(19) United States
(12) Patent Application Publication
(10) Pub. No.: US 2023/0025521 A1
(43) Pub. Date: Jan. 26, 2023

(54) PLANAR TRANSFORMERS WITH MULTIPLE MAGNETIC MATERIALS

(71) Applicant: Navitas Semiconductor Limited, Dublin (IE)

(72) Inventors: Xiucheng Huang, Torrance, CA (US); Bin Li, Pleasanton, CA (US); Weijing Du, Torrance, CA (US); Yun Zhou, Shenzhen (CN)

(73) Assignee: Navitas Semiconductor Limited, Dublin (IE)

(21) Appl. No.: 17/812,632

(22) Filed: Jul. 14, 2022

Related U.S. Application Data
(60) Provisional application No. 63/261,550, filed on Sep. 23, 2021.

(30) Foreign Application Priority Data
Jul. 16, 2021 (CN) 202110807371.0

(51) Int. Cl. H01F 27/28; H01F 27/255; H01F 27/38

(52) U.S. Cl. CPC H01F 27/2804; H01F 27/255; H01F 27/38; H01F 2027/2819

(57) ABSTRACT

Systems and methods for improving winding losses in transformers are disclosed. In one aspect, a transformer includes a first magnetic core having an interior portion and an exterior portion, a second magnetic core in contact with the interior and exterior portions, a plurality of primary and secondary windings formed around the interior portion, where the interior portion is formed from one of a first magnetic material and a second magnetic material, and the exterior portion is formed from one of the first magnetic material and the second magnetic material, where the first magnetic material has different properties than the second magnetic material. In another aspect, the first magnetic core includes a third portion that extends across and is in contact with the interior portion and the exterior portion, where the third portion is formed from one of the first magnetic material and the second magnetic material.

### CROSS-REFERENCE TO RELATED APPLICATIONS

The present application claims priority to Chinese Patent Application No. 202110807371.0 (Attorney Docket No. 096868-1260654-006300CNP) filed on Jul. 16, 2021, entitled “PLANAR TRANSFORMER WITH COMBINATION OF MULTIPLE MAGNETIC MATERIALS”, and U.S. Provisional Patent Application No. 63/261,550 (Attorney Docket No. 096868-1260105-006300USP), filed on Sep. 23, 2021, entitled PLANAR TRANSFORMERS WITH MULTIPLE MAGNETIC MATERIALS, the contents of all of which are incorporated herein by reference in their entirety for all purposes.

### FIELD

The described embodiments relate generally to transformers used in power converters, and more particularly, the present embodiments relate to planar transformers with multiple magnetic materials that can result in reduced winding losses of the planar transformer.

### BACKGROUND

Electronic devices such as computers, servers and televisions, among others, employ one or more electrical power conversion circuits to convert one form of electrical energy to another. Some electrical power conversion circuits convert a high DC voltage to a lower DC voltage using a circuit topology called a half bridge converter. As many electronic devices are sensitive to size and efficiency of the power conversion circuit, new power converters can provide relatively higher efficiency and lower size for the new electronic devices.

### SUMMARY

In some embodiments, a transformer is disclosed. The transformer includes a first magnetic core including an interior portion and an exterior portion, a second magnetic core in contact with the interior portion and the exterior portion, a plurality of primary windings formed around the interior portion, and a plurality of secondary windings formed around the interior portion, where the interior portion includes one of a first magnetic material and a second magnetic material, and the exterior portion includes one of the first magnetic material and the second magnetic material, where the first magnetic material has different properties than the second magnetic material.

In some embodiments, the first magnetic core includes a third portion that extends across and is in contact with the interior portion and the exterior portion.

In some embodiments, the third portion and the second magnetic core are made from the first magnetic material, where the interior portion and the exterior portion are made from the second magnetic material.

In some embodiments, the first magnetic core is formed from the second magnetic material and the second magnetic core is formed from the first magnetic material.

In some embodiments, the exterior portion, the third portion and the first magnetic core are formed from the first magnetic material and the interior portion is formed from the second magnetic material.

In some embodiments, the exterior portion is formed from the second magnetic material, and the third portion, the interior portion and the second magnetic core are formed from the first magnetic material.

In some embodiments, the exterior and interior portions are formed from the first magnetic material, and the third portion and the second magnetic core are formed from the second magnetic material.

In some embodiments, the first magnetic core is formed from one of the first magnetic material and the second magnetic material.

In some embodiments, the first magnetic material has a lower magnetic permeability than the second magnetic material.

In some embodiments, the exterior portion surrounds an outer perimeter of the interior portion.

In some embodiments, the plurality of primary windings and the plurality of secondary windings are enclosed by the first and second magnetic cores.

In some embodiments, the first magnetic material includes magnetic powder material and the second magnetic material includes ferrite material.

In some embodiments, a method of forming a transformer is disclosed. The method includes forming a first magnetic core including an interior portion and an exterior portion, forming a second magnetic core in contact with the interior portion and the exterior portion, forming a plurality of primary windings around the interior portion, and forming a plurality of secondary windings around the interior portion, where the interior portion includes one of a first magnetic material and a second magnetic material, and the exterior portion includes one of the first magnetic material and the second magnetic material, where the first magnetic material has different properties than the second magnetic material.

In some embodiments, in the disclosed method the first magnetic core includes a third portion that extends across and is in contact with the interior portion and the exterior portion.

In some embodiments, in the disclosed method the first magnetic material has a lower magnetic permeability than the second magnetic material.

In some embodiments, in the disclosed method the exterior portion surrounds an outer perimeter of the interior portion.

In some embodiments, in the disclosed method the primary windings and the secondary windings are enclosed by the first and second magnetic cores.

In some embodiments, in the disclosed method the first magnetic material includes magnetic powder material and the second magnetic material includes ferrite material.

In some embodiments, in the disclosed method the third portion and the second magnetic core are made from the first magnetic material, where the interior portion and the exterior portion are made from the second magnetic material.

In some embodiments, in the disclosed method the first magnetic core is formed from the second magnetic material and the second magnetic core is formed from the first magnetic material.

### BRIEF DESCRIPTION OF THE DRAWINGS

FIG. 1 illustrates a planar transformer with a core having multiple sections according to an embodiment of the disclosure;

FIG. 2 illustrates a schematic diagram showing various combination of sub-cores and different types of magnetic materials used in the planar transformer of FIG. 1 according to an embodiment of the disclosure;

FIGS. 3A and 3B illustrate various structure combinations of magnetic core sections and magnetic materials according to an embodiment of the disclosure; and

FIG. 4A illustrates a diagram showing magnetic flux lines for a magnetic core structure with an air gap and with a single high permeability material used in the core. FIG. 4B illustrates a diagram showing magnetic flux lines for the structure which has no air gap and which has multiple core materials with different permeability values according to an embodiment of the disclosure.

### DETAILED DESCRIPTION

Devices, structures and related techniques disclosed herein relate generally to power conversion devices. More specifically, devices, structures and related techniques disclosed herein relate to power conversion circuits using planar transformers that include multiple magnetic materials. In some embodiments, planar transformers using multiple magnetic materials in their core can reduce their winding losses, resulting in an overall improvement in efficiency of the power conversion circuits. In various embodiments, an air gap in a planar transformer can be eliminated and replaced by magnetic materials, resulting in reduction of winding losses. In some embodiments, a planer transformer can include a first magnetic core having an exterior portion and an interior portion and a third portion that extends across and is in contact with the exterior and interior portions, and a second magnetic core that is in contact with the exterior and interior portions, where the exterior portion, the interior portion, the third portion and the second magnetic core can be formed from one of a first magnetic material and a second magnetic material. The first magnetic material can have a lower magnetic permeability than the second magnetic material. Embodiments of the disclosure can prevent core saturation, thereby reduce the winding losses in the planar transformer.

In various embodiments, methods for combining magnetic materials with varying permeabilities in various sections of the magnetic cores are disclosed. The disclosed methods can keep a value of an overall permeability of the planar transformer at a relatively unchanged value. Various inventive embodiments are described herein, including methods, processes, systems, devices, and the like.

Several illustrative embodiments will now be described with respect to the accompanying drawings, which form a part hereof. The ensuing description provides embodiment(s) only and is not intended to limit the scope, applicability, or configuration of the disclosure. Rather, the ensuing description of the embodiment(s) will provide those skilled in the art with an enabling description for implementing one or more embodiments. It is understood that various changes may be made in the function and arrangement of elements without departing from the spirit and scope of this disclosure. In the following description, for the purposes of explanation, specific details are set forth in order to provide a thorough understanding of certain inventive embodiments. However, it will be apparent that various embodiments may be practiced without these specific details. The figures and description are not intended to be restrictive. The word “example” or “exemplary” is used herein to mean “serving as an example, instance, or illustration.” Any embodiment or design described herein as “exemplary” or “example” is not necessarily to be construed as preferred or advantageous over other embodiments or designs.

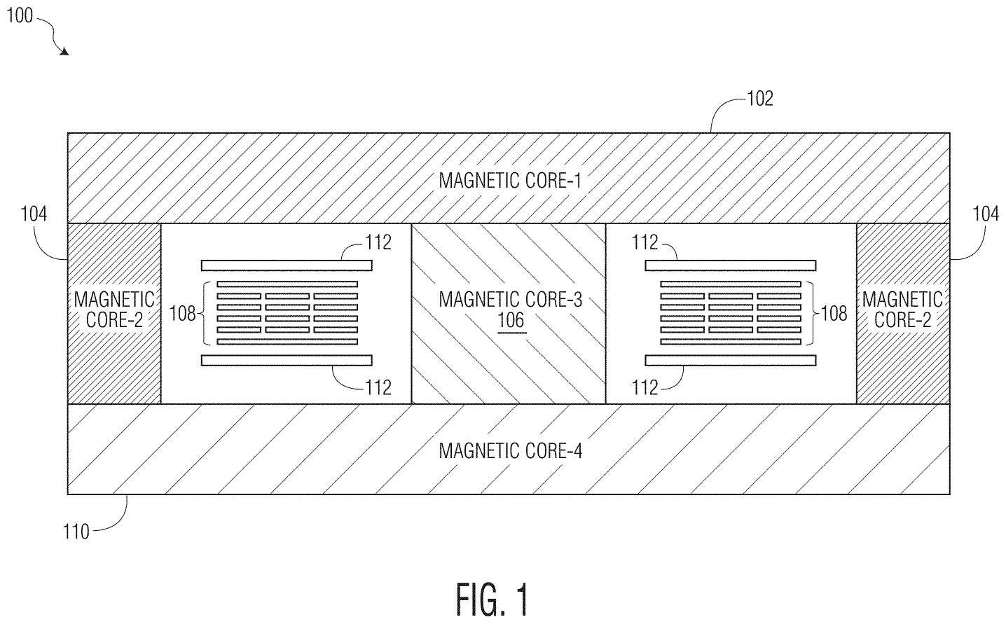

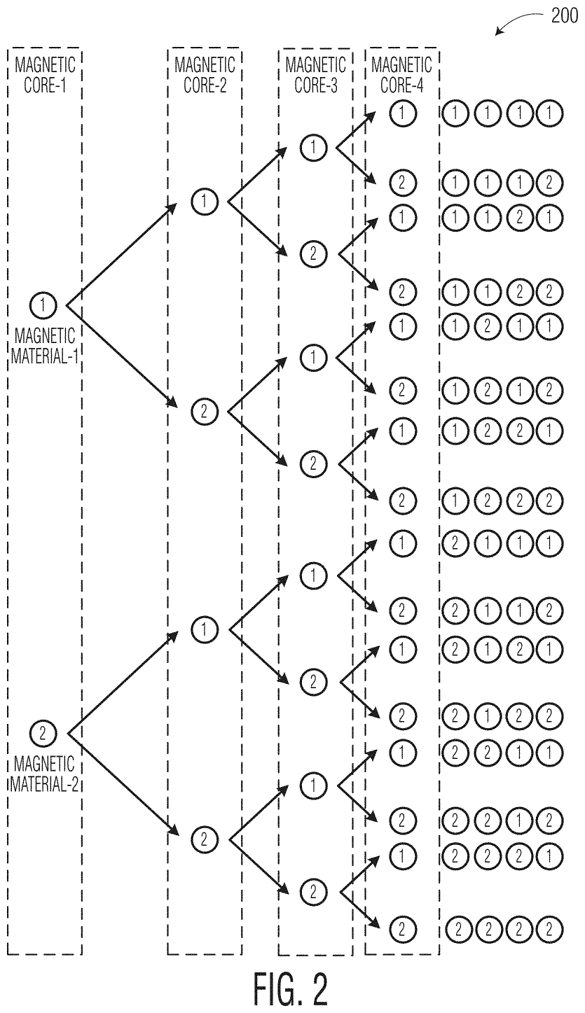

FIG. 1 illustrates a planar transformer 100 according to an embodiment of the disclosure. As shown in FIG. 1, planar transformer 100 can include a first magnetic core 102, a second magnetic core 104, a third magnetic core 106 and a fourth magnetic core 110. Planar transformer 100 can also include primary windings 108 and secondary windings 112. The magnetic cores 102, 104 and 106 can form a shape of an E and magnetic core 110 can be in shape of an I. In the illustrated embodiment, there are no air gaps in the magnetic core of the planar transformer 100. With no air gaps, magnetic flux leakage surrounding an air gap can be eliminated resulting in reduced winding losses in the planar transformer 100. Moreover, with no air gaps, a complete magnetic circuit can be formed in the planar transformer 100. Further, the magnetic cores 102, 104, 106 and 110 can be formed from various magnetic materials that are dissimilar and have different permeability values. Magnetic cores 102, 104, 106 and 110 may also be referred to as sub-cores. Magnetic cores 102, 104, 106 and 110 can be formed, for example, from a first magnetic material, and a second magnetic material, or a combination of the first and second magnetic materials. In various embodiments, disclosed structures and methods can be utilized for any suitable planer transformer core shapes such as, but not limited to, EIR, EI, U, or C-shaped cores, and to any number of winding layers in the planar transformer.

In some embodiments, the first magnetic material can have a permeability value that is relatively high. The permeability value for the first magnetic material can range from 800 to 10,000 H/m. As appreciated by one of ordinary skill in the art having the benefit of this disclosure, the permeability of the first magnetic material can be set to any suitable value. In various embodiments, the first magnetic material can be a ferrite material. In some embodiments, the second magnetic material can have a permeability value that is relatively low. In various embodiments, the permeability value for the second magnetic material can range from 2 to 15 H/m, while in other embodiments the permeability value can range from 12 to 45 H/m, and in yet other embodiments the permeability value can range from 5 to 160 H/m. As appreciated by one of ordinary skill in the art having the benefit of this disclosure, the permeability of the second magnetic material can be set to any suitable value. In various embodiments, the second magnetic material can be a magnetic powder.

In some embodiments, a relatively high permeability of a ferrite core can provide a low reluctance path for magnetic flux flow which can maintain a magnetizing inductance (Lₘ) of the planar transformer 100 at a relatively high level. Furthermore, a magnetic powder core may have a relatively low permeability, thus enabling storage of relatively large amounts of energy which can help prevent saturation of the planar transformer 100. In various embodiments, a planar transformer can be formed by a combination of magnetic cores 102, 104, 106 and 110 using a first magnetic material and a second magnetic material. This can result in various combinations (Cₙ). Cₙ can be expressed as:

Cₙ=M^{N}−2

where N is the number of sub-cores and M indicates the various types of magnetic materials used in the planar transformer 100. As an example, the above equation can generate 14 combinations using four magnetic sub-cores (M=4) and two magnetic materials (N=2). As appreciated by one of ordinary skill in the art having the benefit of this disclosure, the number of sub-cores and the number of magnetic materials can be set to any suitable value.

FIG. 2 illustrates a diagram 200 showing combinations of 4 sub-cores and 2 different types of magnetic materials, according to an embodiment of the disclosure. As can be seen in diagram 200, there are two magnetic materials available for each sub-core. In diagram 200, \textcircled{1} and \textcircled{2}, respectively, represent a first magnetic material (magnetic material-1) and a second magnetic material (magnetic material-2). In the illustrated embodiment, the first magnetic material can be a ferrite material and the second magnetic material can be a magnetic powder. In the illustrated embodiment, magnetizing inductance Lₘ and leakage inductance Lₖ of the planar transformer 100 may be kept unchanged thus an effective permeability of planar transformer 100 can remain unchanged in order to avoid affecting the operation of the power conversion circuit using the planer transformer 100. Combinations of various sub-cores and different magnetic materials can be expressed in form of a four-dimensional coordinate, as follows:
(1,1,1,2), (1,1,2,1), (1,1,2,2), (1,2,1,1), (1,2,1,2), (1,2,2,1), (1,2,2,2)
(2,1,1,1), (2,1,1,2), (2,1,2,1), (2,1,2,2), (2,2,1,1), (2,2,1,2), (2,2,2,1)

In the planar transformer 100, the magnetic core 102 can be symmetrical with the magnetic core 104. Therefore, among the 14 combinations there can be 4 combinations that are identical. Therefore 10 unique combinations remain:
(1,1,1,2), (1,1,2,1), (1,1,2,2), (1,2,1,1), (1,2,1,2)
(1,2,2,1), (1,2,2,2), (2,1,1,2), (2,1,2,2), (2,2,1,2)

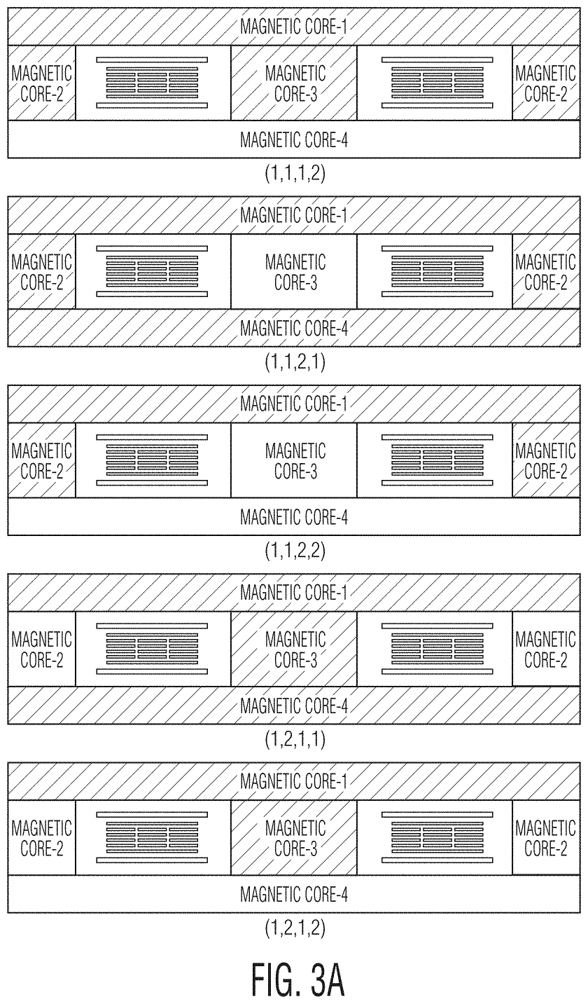

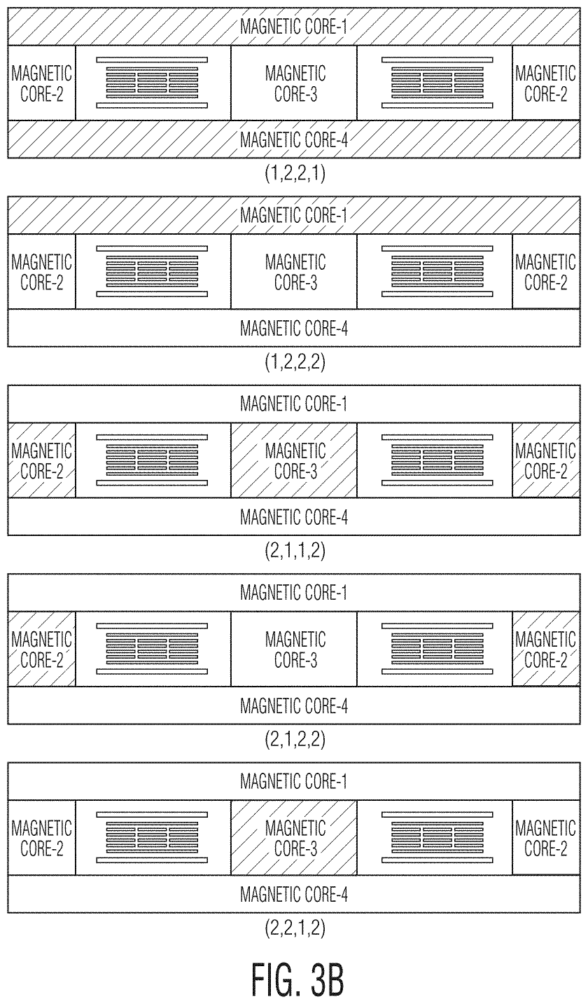

These ten combinations of magnetic core sections and magnetic core materials are illustrated in FIGS. 3A and 3B, according to embodiments of the disclosure. Example winding losses for these ten combinations of magnetic core sections and magnetic core materials are illustrated in table 1:

TABLE 1

| | Winding | Permeability of | Permeability of |
|---|---|---|---|
| | loss | magnetic material-1 | magnetic material-2 |
| Core structure | (W) | (H/m) | (H/m) |
| With air gap | 4.93 | 1196 | 1196 |
| (1,1,1,2) | 1.33 | 1196 | 29.66 |
| (1,1,2,1) | 3.22 | 1196 | 9.34 |
| (1,1,2,2) | 1.57 | 1196 | 41.78 |
| (1,2,1,1) | 4.27 | 1196 | 3.72 |
| (1,2,1,2) | 2.08 | 1196 | 35.22 |
| (1,2,2,1) | 1.38 | 1196 | 14.28 |
| (1,2,2,2) | 1.49 | 1196 | 47.35 |
| (2,1,1,2) | 1.13 | 1196 | 59.67 |
| (2,1,2,2) | 1.32 | 1196 | 72.68 |
| (2,2,1,2) | 1.18 | 1196 | 65.58 |

FIGS. 3A and 3B show 10 structures with various magnetic core sections and different magnetic materials as described above. As can be seen in table 1, various combinations of magnetic sections and magnetic core material can provide a reduction of winding losses compared to a core structure having an air gap and having a single material used in its magnetic core sections. As an example, structure (2,1,1,2) can provide relatively large reduction in winding losses, for example, the winding loss for the structure (2,1,1,2) can be 1.13 W. In some embodiments, the first magnetic core can have a shape of an E, where the first magnetic core can have an exterior portion and an interior portion. In various embodiments, the exterior portion and interior portion can be formed from different magnetic material. The reduction in winding losses can improve efficiency of the power conversion device, for example, in a 65 W power converter, efficiency improvement of 1% can be achieved.

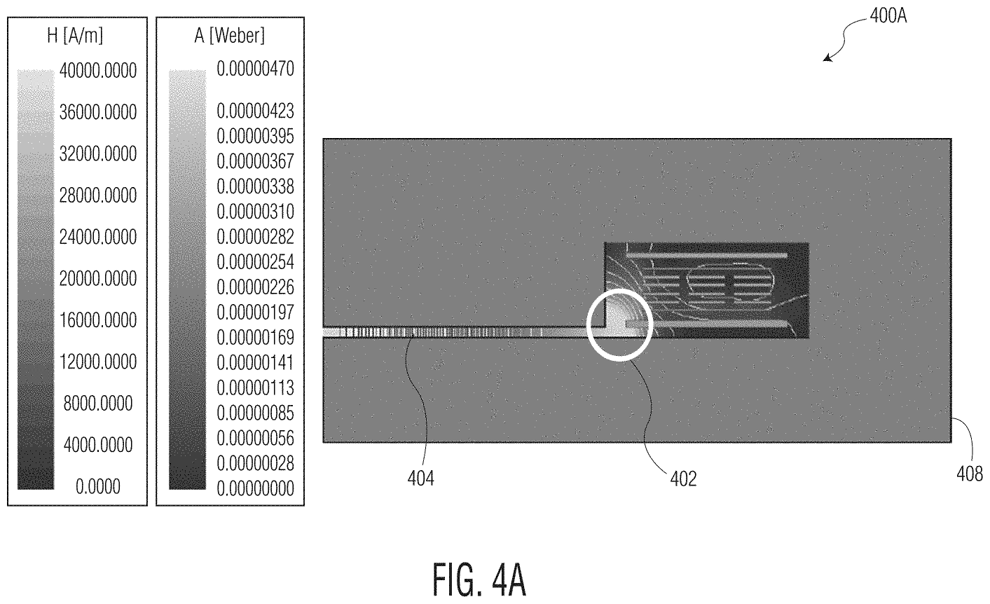

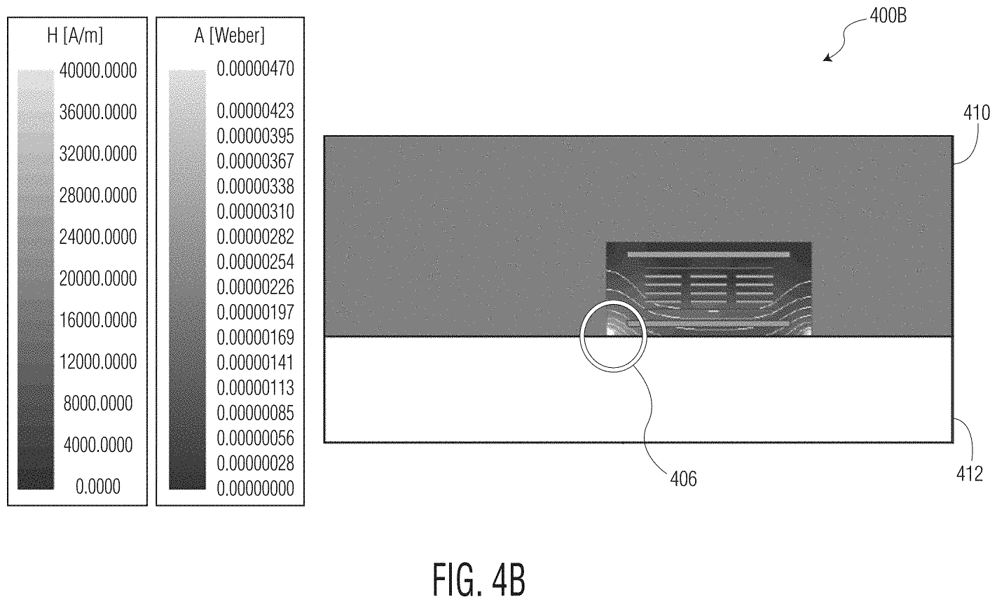

FIG. 4A illustrates a diagram 400A showing magnetic flux lines for a magnetic core structure with an air gap 404 and with a single high permeability material 408 used in the core. FIG. 4B illustrates a diagram 400B showing magnetic flux lines for the combination (2,1,1,2) structure which has no air gap and which has multiple core materials with different permeability values used in its core sections 410 and 412. As can be seen, the magnetic flux in diagram 400A in section 402 is relatively large compared to the magnetic flux in diagram 400B of section 406. The relatively low magnetic flux in section 406 enables the structure of combination (2,1,1,2) structure to have relatively low winding losses.

In some embodiments, combination of the structures and techniques disclosed herein can be utilized to achieve a reduction in planar transformer winding losses. Although structures and methods are described and illustrated herein with respect to one particular configuration of a planar transformer, embodiments of the disclosure are suitable for use with other configurations of planar transformers, such as, but not limited to, U or C-shape transformers. Further, embodiments of the disclosure are suitable for use with transformers having multiple magnetic materials. Moreover, embodiments of the disclosure are suitable for use with other transformer configurations, such as, but not limited to, non-planar transformers.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

What is claimed is:

1. A transformer comprising:
a first magnetic core including an interior portion and an exterior portion;
a second magnetic core in contact with the interior portion and the exterior portion;
a plurality of primary windings formed around the interior portion; and
a plurality of secondary windings formed around the interior portion;
wherein the interior portion comprises one of a first magnetic material and a second magnetic material, and the exterior portion comprises one of the first magnetic material and the second magnetic material, wherein the first magnetic material has different properties than the second magnetic material.

2. The transformer of claim 1, wherein the first magnetic core comprises a third portion that extends across and is in contact with the interior portion and the exterior portion.

3. The transformer of claim 2, wherein the third portion and the second magnetic core are made from the first magnetic material, and wherein the interior portion and the exterior portion are made from the second magnetic material.

4. The transformer of claim 2, wherein the first magnetic core is formed from the second magnetic material and the second magnetic core is formed from the first magnetic material.

5. The transformer of claim 2, wherein the exterior portion, the third portion and the first magnetic core are formed from the first magnetic material and the interior portion is formed from the second magnetic material.

6. The transformer of claim 2, wherein the exterior portion is formed from the second magnetic material, and the third portion, the interior portion and the second magnetic core are formed from the first magnetic material.

7. The transformer of claim 2, wherein the exterior and interior portions are formed from the first magnetic material, and the third portion and the second magnetic core are formed from the second magnetic material.

8. The transformer of claim 1, wherein the first magnetic core is formed from one of the first magnetic material and the second magnetic material.

9. The transformer of claim 1, wherein the first magnetic material has a lower magnetic permeability than the second magnetic material.

10. The transformer of claim 1, wherein the exterior portion surrounds an outer perimeter of the interior portion.

11. The transformer of claim 1, wherein the plurality of primary windings and the plurality of secondary windings are enclosed by the first and second magnetic cores.

12. The transformer of claim 1, wherein the first magnetic material comprises magnetic powder material and the second magnetic material comprises ferrite material.

13. A method of forming a transformer, the method comprising:
forming a first magnetic core including an interior portion and an exterior portion;
forming a second magnetic core in contact with the interior portion and the exterior portion;
forming a plurality of primary windings around the interior portion; and
forming a plurality of secondary windings around the interior portion;
wherein the interior portion comprises one of a first magnetic material and a second magnetic material, and the exterior portion comprises one of the first magnetic material and the second magnetic material, wherein the first magnetic material has different properties than the second magnetic material.

14. The method of claim 13, wherein the first magnetic core comprises a third portion that extends across and is in contact with the interior portion and the exterior portion.

15. The method of claim 13, wherein the first magnetic material has a lower magnetic permeability than the second magnetic material.

16. The method of claim 13, wherein the exterior portion surrounds an outer perimeter of the interior portion.

17. The method of claim 13, wherein the primary windings and the secondary windings are enclosed by the first and second magnetic cores.

18. The method of claim 13, wherein the first magnetic material comprises magnetic powder material and the second magnetic material comprises ferrite material.

19. The method of claim 14, wherein the third portion and the second magnetic core are made from the first magnetic material, and wherein the interior portion and the exterior portion are made from the second magnetic material.

20. The method of claim 14, wherein the first magnetic core is formed from the second magnetic material and the second magnetic core is formed from the first magnetic material.
